(19) United States
(12) Patent Application Publication
(10) Pub. No.: US 2019/0044917 A1
(43) Pub. Date: Feb. 7, 2019

(54) SYSTEM FOR SECURE VERIFICATION OF IDENTITY DATA

(71) Applicant: Bank of America Corporation, Charlotte, NC (US)

(72) Inventors: Phillip Wade Mork, Huntersville, NC (US); Richard Paxton Church, Charlotte, NC (US); Zafer Mohamed, Charlotte, NC (US)

(21) Appl. No.: 15/669,437

(22) Filed: Aug. 4, 2017

(51) Int. Cl. H04L 29/06

(52) U.S. Cl. CPC H04L 63/0428; G06Q 2220/00; H04L 63/08

(57) ABSTRACT

Embodiments of the present invention provide a system for secure verification of identity data. A request for verification of a customer for a client's product or service is received, the request including a baseline set of customer information. This received baseline set of customer information is compared to customer information stored on a private block chain network to determine whether the received baseline set of customer information matches the stored information for the same customer. If there is a match, a virtual customer key is generated or copied from the private block chain network and transmitted to a client system. The client system can then provide subsequent requests for customer identity verification or additional information about that customer by presenting the virtual key.

### BACKGROUND

Verification of customer identities requires strict data security and system communication networks that are difficult to configure and manage. Entities with the sophisticated and secure data and communication networks for performing customer identity verifications can utilize their resources to provide identity verification services to entities without the sophisticated systems in place.

Therefore, a need exists to securely provide authentication and verification of individuals without compromising the secure data networks and secure communication networks of the entity providing the verification service.

### BRIEF SUMMARY

The following presents a summary of certain embodiments of the invention. This summary is not intended to identify key or critical elements of all embodiments nor delineate the scope of any or all embodiments. Its sole purpose is to present certain concepts and elements of one or more embodiments in a summary form as a prelude to the more detailed description that follows.

Embodiments of the present invention address the above needs and/or achieve other advantages by providing apparatuses (e.g., a system, computer program product and/or other devices) and methods for secure verification of identity data. The system embodiments may comprise one or more memory devices having computer readable program code stored thereon, a communication device, and one or more processing devices operatively coupled to the one or more memory devices, wherein the one or more processing devices are configured to execute the computer readable program code to carry out the invention. In computer program product embodiments of the invention, the computer program product comprises at least one non-transitory computer readable medium comprising computer readable instructions for carrying out the invention. Computer implemented method embodiments of the invention may comprise providing a computing system comprising a computer processing device and a non-transitory computer readable medium, where the computer readable medium comprises configured computer program instruction code, such that when said instruction code is operated by said computer processing device, said computer processing device performs certain operations to carry out the invention.

For sample, illustrative purposes, system environments will be summarized. The system may involve receiving, from a client system, a request for verification of a customer for a product or service of the client, wherein the request for verification of the customer comprises baseline customer information. The system may then compare the received baseline customer information to stored baseline customer information on a private block chain network to determine whether the received baseline customer information matches the stored baseline customer information on the private block chain network. In response to determining that the received baseline customer information does not match the stored customer information on the private block chain network, the system will transmit, to the client system, an indication that the request for verification of the customer was not successful. Alternatively, in response to determining that the received baseline customer information does match the stored baseline customer information on the private block chain network, the system can transmit, to the client system, a customer key associated with the stored customer information on the private block chain network, wherein the customer key includes an indication that the customer is verified.

In some such embodiments, the private block chain network comprises a distributed network of nodes managed by one or more entities, wherein the nodes are operatively coupled to each other, have at least a portion of a private block chain ledger, and share information on the ledger through electronic communication. In some embodiments, the customer key does not comprise personally identifiable information of the customer.

The system may additionally involve receiving, from the client system, the customer key and an indication that the customer has signed up for the product or service of the client. The system can then associate the customer key with the stored customer information on the private block chain network to locate the stored customer information on the private block chain network, and record the indication that the customer has signed up for the product or service of the client in the private block chain network.

In some embodiments, the system may provide a public or semi-private portal to the client system, wherein the portal comprises encrypted information about the customer and a plurality of additional customers. The system can then receive the customer key and a request for additional customer information from the client system and, in response to receiving the customer key, decrypt the encrypted information about the customer on the public or semi-private portal for only the client system. In some such embodiments, the decrypted portion of the stored customer information is displayed on the public or semi-private portal for only the client system for a predetermined period of time.

In some embodiments, the system may be configured to receive, from the client system, the customer key and a request for a subsequent verification of the customer. The system may then associate the customer key with the stored customer information on the private block chain network to determine whether the stored baseline customer information in the private block chain network has changed since the customer key was transmitted to the client system. In response to determining that the baseline customer information has changed, the system can transmit, to the client system, an indication of a failure of the subsequent verification of the customer. Alternatively, in response to determining that the baseline customer information has not changed, the system may transmit, to the client system, an indication of a success of the subsequent verification of the customer.

The system may also involve receiving the customer key and a request for additional customer information from the client system, and determining that the additional customer information is associated with an increased level of authorization. The system can then request authorization credentials from the client system, wherein the authorization credentials comprise supplemental customer information beyond the baseline customer information or a unique passcode associated with the customer. Once the system has received the authorization credentials from the client system, the system can extract, from the private block chain network, the additional customer information, and transmit the extracted additional customer information to the client system. In some such embodiments, the extracted additional customer information is encrypted and transmitted to the client system via a secure communication channel.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 provides a block diagram illustrating a system environment for secure verification of identity data, in accordance with an embodiment of the invention;

FIG. 2 provides a block diagram illustrating the managing entity system of FIG. 1, in accordance with an embodiment of the invention;

FIG. 3 provides a block diagram illustrating a communication network involving the client entity system, the managing entity system, and a block chain network embodiments of the customer identification database system of FIG. 1, in accordance with an embodiment of the invention;

FIG. 4 provides a flowchart illustrating a process for secure verification of identity data, in accordance with an embodiment of the invention;

FIG. 5 provides a flowchart illustrating a process for updating a customer information database, in accordance with an embodiment of the invention;

FIG. 6 provides a flowchart illustrating a process for providing an online portal to a client system for viewing customer information in response to the client system providing the customer key, in accordance with an embodiment of the invention;

FIG. 7 provides a flowchart illustrating a process for subsequent verification of an identity of a customer, in accordance with an embodiment of the invention; and

FIG. 8 provides a flowchart illustrating a process for providing additional customer information to the client system, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

Embodiments of the present invention provide a system for secure verification of identity data. A request for verification of a customer for a client's product or service is received, the request including a baseline set of customer information. This received baseline set of customer information is compared to customer information stored on a private block chain network to determine whether the received baseline set of customer information matches the stored information for the same customer. If there is no match, an indication of a failure of the identity verification is transmitted to a client system. If there is a match, a virtual customer key is generated or copied from the private block chain network and transmitted to the client system.

Once the client has signed the customer up for the product or service of the client, the client system can transmit an indication of the enrollment, allowing the system to record the new enrollment event in on a node and distributed ledger of the private block chain network.

The client system also provide subsequent requests for customer identity verification or additional information about that customer by presenting the virtual key. For example, the managing entity system can provide a public or semi-private portal (e.g., a web portal) to the client system. The client system can present the customer key to this portal in return for a subsequent verification of the customer and/or additional information about that customer.

In another embodiment, the client system can present the customer key to the managing entity, along with a request for subsequent verification of the customer. The managing entity can then take the customer key, associate it with data in the private block chain network to identify the customer in question, and determine whether the baseline customer information in the private block chain network has changed since the customer key was originally transmitted to the client system. If there has been a change in the baseline customer information, the system can transmit, to the client system, an indication of a failure of the subsequent verification of the customer. If there has been no match, the system can transmit an indication of a successful subsequent verification of the customer.

In yet another embodiment, once the client entity system has received the customer key, the client system can request additional information about the customer. In such embodiments, the managing entity system may require additional authorization credentials before allowing the client system to access or receive additional customer information.

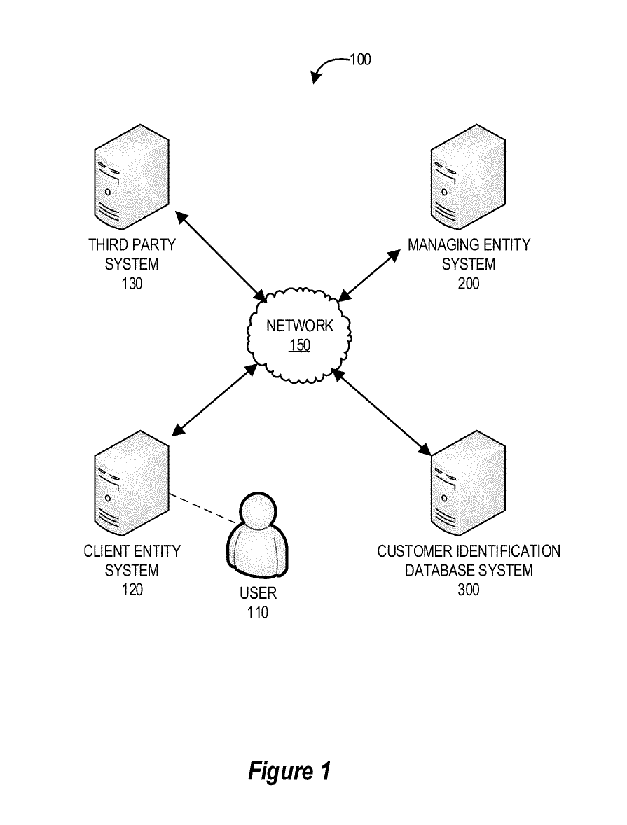

FIG. 1 provides a block diagram illustrating a system and environment 100, in accordance with an embodiment of the invention. As illustrated in FIG. 1, the environment 100 includes a managing entity system 200, a customer identification database system 300, a client entity system 120, and a third party system 130 in communication across a network 150. The system environment 100 may also include a user 110, where the user 110 represents a customer of a client entity associated with the client entity system 120, a managing entity associated with the managing entity system 200, and/or the third party system 130. In some embodiments, the user 110 represents an individual asserting to have the identity of the user 110, and the system environment 100 is configured to verify the identity based on certain information about the user 110. While a single user 110 is shown in FIG. 1, it is contemplated that multiple additional users (not shown) may be associated with the system environment 100. The descriptions provided herein of a single user 110 will be indicative of how any of the plurality of users can interact with the system environment 100.

As mentioned above, the managing entity system 200, the customer identification database system 300, the client entity system 120, and/or the third party system 130 are configured to communicate over a network 150. The network 150 may include a local area network (LAN), a wide area network (WAN), and/or a global area network (GAN). The network 150 may provide for wireline, wireless, or a combination of wireline and wireless communication between devices in the network. In one embodiment, the network 150 includes the Internet. In one embodiment, the network 150 includes a wireless telephone network.

The managing entity system 200 is generally controlled by a managing entity, which may be one or more entities, organizations, partnerships, and the like, that are in the business of providing customer identity verifications as a service. In some embodiments, the managing entity is a financial institution that collects and stores customer at least a baseline amount of information for each customer that opens an account with that institution and/or enrolls in a product or service of the financial institution. In such cases, the managing entity may also own, control, or otherwise have access to a customer identification database system 300 that stores information about each customer of the managing entity system. The managing entity may configure the managing entity system 200 to perform certain matching, verifying, encrypting, recording, and/or extracting actions on or to the customer identification database system 300.

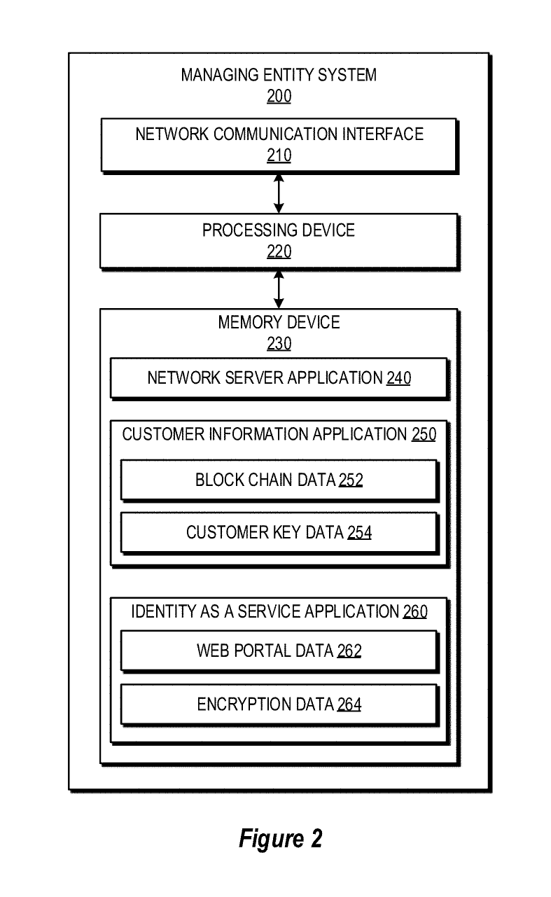

Additionally, the managing entity system 200 may provide its identity verification service to one or more client entities, as represented by the client entity system 120. Of course, the managing entity system 200 may provide this service to multiple clients, and the inclusion of a single client entity system 120 is not meant to be limiting. In this way, the client entity system 120 can request an identity verification of one of its customers (e.g., the user 110) by the managing entity system 200, via the network 150. The managing entity system 200 is described in more detail with respect to FIG. 2.

The customer identification database system 300 may be any data storage device, network of data storage devices, and the like. The customer identification database system 300 may be configured to store, record, log, relate, protect, compile, and otherwise store information and data about a plurality of customers, including the user 110, in a manner that allows the managing entity system 200, the client entity system 120, and/or a third party system 130 to identify, compare, encrypt, decrypt, and extract the information when needed. The customer identification database system 300 may be owned, managed, or controlled be the managing entity system 200 and/or a third party system 130. For example, the customer identification database system 300 may be owned or controlled by a conglomerate of financial institutions that are each able to record customer-specific information and data within the customer identification database system 300.

The customer information stored in the customer identification database system 300 may be personally identifiable information, information about specific products or services in which a customer is enrolled, statistical information about the customer, biographical information of the customer, biometric information of the customer, and the like. For example, the customer identification database system 300 may store any of the following information for each customer, if acquired and recorded by the managing entity system 200 and/or a third party system 130: legal name, maiden name, aliases, physical address(es), email address(es), telephone numbers, financial account names, financial account numbers, social security number, driver's license number, height, hair color, eye color, age, birthdate, spouse or other family information, biometric information, previous addresses, previous financial accounts or financial products, and the like.

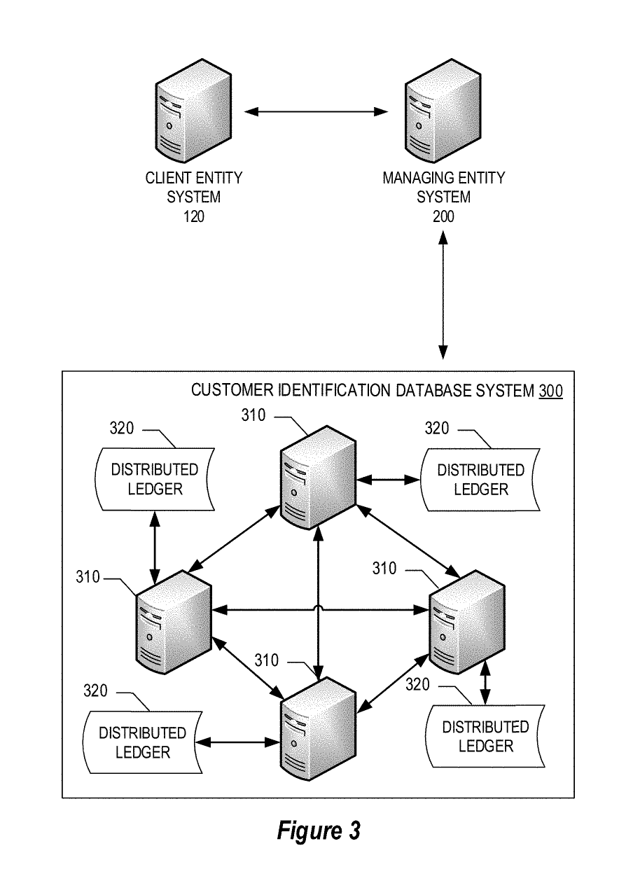

In some embodiments, at least a portion of the customer identification database system 300 comprises a block chain network of multiple nodes and distributed ledgers. The nodes and ledgers of such a block chain network may be managed or otherwise controlled by the managing entity system 200, a third party system 130, a conglomerate of financial institutions, a data security entity, or any combination thereof. The block chain network embodiment of the customer identification database system 300, and how it fits in to a communication structure with the managing entity system 200 and the client entity system 120 is illustrated in further detail with respect to FIG. 3.

The client entity system 120 is any system controlled by an entity that is a client of the managing entity system 200, and the customer identity verification service in particular. The client entity may be a financial technology company, an insurance company, or any other entity that is required to verify (or would like to verify) a purported identity of a customer (e.g., the user 110) requesting enrollment in a product or service of the client entity.

The client entity system 120 may have its own interactions with the user 110, where the user 110 is requesting access to, or enrollment in, a product or service of the client entity. The client entity may not have the resources at its own disposal to perform the proper due diligence or background checks to make sure the identity provided by the user 110 is the correct (or at least a correct) customer identity. Therefore, the client entity system 120 can request a baseline amount of customer information from the user 110, and send an identity verification request along with the baseline customer information across the network 150 to the managing entity system 200.

The client entity system 120 can also receive information from the managing entity system 200 and/or the customer identification database system 300 including, but not limited to, a verification of the identity of the user 110, an indication that the identity was not verified, a customer key for the user 110, additional information about the user, and the like. Of course, these examples are merely for illustrative purposes, as the client entity system 120 can communicate freely over the network 150 (including through dedicated, secured communication channels) with the managing entity system 200 and/or the customer identification database system 300 to perform any of the process steps described herein.

Finally, the third party system 130 may be one or more systems controlled by third party entities that perform one or more process steps of the inventions described herein. For example, the third party system 130 may represent one or more financial institutions that, along with the managing entity, control and manage the customer identification database system 300. Additionally or alternatively, the third party system 130 may include an online portal through which the managing entity system 200 provides encrypted and/or decrypted customer information from the customer identification database system 300 to the client entity system 120.

FIG. 2 provides a block diagram illustrating the managing entity system 200, in greater detail, in accordance with embodiments of the invention. As illustrated in FIG. 2, in one embodiment of the invention, the managing entity system 200 includes one or more processing devices 220 operatively coupled to a network communication interface 210 and a memory device 230. In certain embodiments, the managing entity system 200 is operated by a first entity, such as a financial institution, while in other embodiments, the managing entity system 200 is operated by an entity other than a financial institution.

It should be understood that the memory device 230 may include one or more databases or other data structures/repositories. The memory device 230 also includes computer-executable program code that instructs the processing device 220 to operate the network communication interface 210 to perform certain communication functions of the managing entity system 200 described herein. For example, in one embodiment of the managing entity system 200, the memory device 230 includes, but is not limited to, a network server application 240, a customer information application 250 which includes block chain data 252 and customer key data 254, an identity as a service application 260 which includes web portal data 262, encryption data 264, and other computer-executable instructions or other data. The computer-executable program code of the network server application 240, the customer information application 250, and/or the identity as a service application 260 may instruct the processing device 220 to perform certain logic, data-processing, and data-storing functions of the managing entity system 200 described herein, as well as communication functions of the managing entity system 200.

In one embodiment, the customer information application 250 includes block chain data 252 and customer key data 254. The block chain data 252 may comprise information about how to access a distributed block chain network, as described with respect to FIG. 3. For example, the block chain data 252 may comprise commands, instructions, data locations, timing information, logic functions, and the like for causing the managing entity system 200, and the customer information application 250 in particular, to access, read, write, encrypt, and otherwise utilize a block chain network.

The customer key data 254 may include key generating instructions, logic, or other information for creating a customer key for an individual in response to receiving a request for verification of that individual. This customer key data 254 may be associated with the block chain data 252 in that customer keys may be generated based off of the block chain data 252, the information extracted from a block chain using the block chain data 252, the customer key data 254 may be instructive on a location of an individual's information within a block chain network, and the like.

In one embodiment, the identity as a service application 260 includes the web portal data 262 and the encryption data 264. The web portal data 262 may include instructions, logic, and other information for allowing the managing entity system 200, and the identity as a service application 260 in particular, to provide an online, web-based portal to clients or third parties (e.g., the client system 120). The encryption data 264 can be used by the identity as a service application to protect additional information about an individual from a client's system by providing instructions or an encryption key for encrypting customer identification data when desired.

The network server application 240, the customer information application 250, and the identity as a service application 260 are configured to invoke or use the block chain data 252, the customer key data 254, the web portal data 262, the encryption data 264, and the like when communicating through the network communication interface 210 with the customer identification database system 300, the client entity system 120, and/or a third party system 130.

As used herein, a “communication interface” generally includes a modem, server, transceiver, and/or other device for communicating with other devices on a network, and/or a user interface for communicating with one or more customers. Referring again to FIG. 2, the network communication interface 210 is a communication interface having one or more communication devices configured to communicate with one or more other devices on the network 150, such as the customer identification database system 300, the client entity system 120, the third party system 130, and the like. The processing device 220 is configured to use the network communication interface 210 to transmit and/or receive data and/or commands to and/or from the other devices connected to the network 150.

FIG. 3 illustrates one system environment 301 for a managing entity system 200 to provide an identity verification service to a client entity system 120 based on the managing entity system's 200 use of, and interaction with, a block chain network embodiment of the customer identification database system 300.

Rather than utilizing a centralized database of transaction information as discussed with reference to some embodiments above, other various embodiments of the invention may use a decentralized block chain configuration or architecture as shown in FIG. 3 in order to facilitate a rights management protocol in a block chain distributed network or a tiered dedicated block chains network. Such a decentralized block chain configuration ensures accurate mapping transaction data to financial institutions, merchants, third parties, and/or customers. Accordingly, a block chain configuration may be used to maintain an accurate ledger of customer information, customer data, customer account information, security levels required for access to certain customer information, and the like. As mentioned above, the distributed ledgers may keep records on any of the following data and information types for each customer: legal name, maiden name, aliases, physical address(es), email address(es), telephone numbers, financial account names, financial account numbers, social security number, driver's license number, height, hair color, eye color, age, birthdate, spouse or other family information, biometric information, previous addresses, previous financial accounts or financial products, and the like.

A block chain or blockchain is a distributed database that maintains a list of data records, the security of which is enhanced by the distributed nature of the block chain. A block chain typically includes several nodes, which may be one or more systems, machines, computers, databases, data stores or the like operably connected with one another. In some cases, each of the nodes or multiple nodes are maintained by different entities. A block chain typically works without a central repository or single administrator. One well-known application of a block chain is the public ledger of transactions for cryptocurrencies such as used in bitcoin. The data records recorded in the block chain are enforced cryptographically and stored on the nodes of the block chain.

A block chain provides numerous advantages over traditional databases. A large number of nodes of a block chain may reach a consensus regarding the validity of a transaction contained on the transaction ledger. Similarly, when multiple versions of a document or transaction exits on the ledger, multiple nodes can converge on the most up-to-date version of the transaction. For example, in the case of a virtual currency transaction, any node within the block chain that creates a transaction can determine within a level of certainty whether the transaction can take place and become final by confirming that no conflicting transactions (i.e., the same currency unit has not already been spent) confirmed by the block chain elsewhere.

The block chain typically has two primary types of records. The first type is the transaction type, which consists of the actual data stored in the block chain. The second type is the block type, which are records that confirm when and in what sequence certain transactions became recorded as part of the block chain. Transactions are created by participants using the block chain in its normal course of business, (e.g., when someone sends cryptocurrency to another person), and blocks are created by users known as “miners” who use specialized software/equipment to create blocks. Users of the block chain create transactions that are passed around to various nodes of the block chain. A “valid” transaction is one that can be validated based on a set of rules that are defined by the particular system implementing the block chain. For example, in the case of cryptocurrencies, a valid transaction is one that is digitally signed, spent from a valid digital wallet and, in some cases, meets other criteria. In some block chain systems, miners are incentivized to create blocks by a rewards structure that offers a pre-defined per-block reward and/or payments offered within the transactions validated themselves. Thus, when a miner successfully validates a transaction on the block chain, the miner may receive rewards and/or payments as an incentive to continue creating new blocks.

As mentioned above and referring to FIG. 3, a block chain is typically decentralized—meaning that a distributed ledger 320 (i.e., a decentralized ledger) is maintained on multiple nodes 310 of the block chain. One node in the block chain may have a complete or partial copy of the entire ledger or set of transactions and/or blocks on the block chain. Customer information and data is recorded or otherwise initiated at a node of a block chain and communicated to the various nodes of the block chain. Any of the nodes can validate customer information, add a copy of the customer information of the block chain, and/or broadcast the customer information, its validation (in the form of a block) and/or other data to other nodes. As used with respect to recording and spreading customer information within the block chain network, the term “validation” refers to a high confidence that the data being input at a node is correct and true, and normally is based on a confidence in the entity in control of that node at the time the data is input. Other data stored within the distributed ledgers may include time-stamping, such as is used in cryptocurrency block chains.

By storing the customer information on a privately held and secure distributed block chain network, and by keeping this customer identification database system 300 separated from the client entity system, the managing entity can ensure that the data held on the customer identification database system 300 is securely held and is not accessible to unapproved access from any third parties.

While some block chain networks are considered “public” because there are little to no restrictions on which individuals or entities can control or record events on a node, the customer identification database system 300 block chain network described herein can be considered a “private” or “semi-private” block chain network because the ownership of all or a majority of the nodes is controlled by a trusted institution. For example, all nodes may be controlled by the same managing institution with proper checks and balances implemented to guarantee the employees entering information in the block chain network are trusted. In another example, the nodes may be managed by multiple different entities, all of which are trusted by the other entities to act in good faith and therefore maintain a secure and accurate customer identification database system.

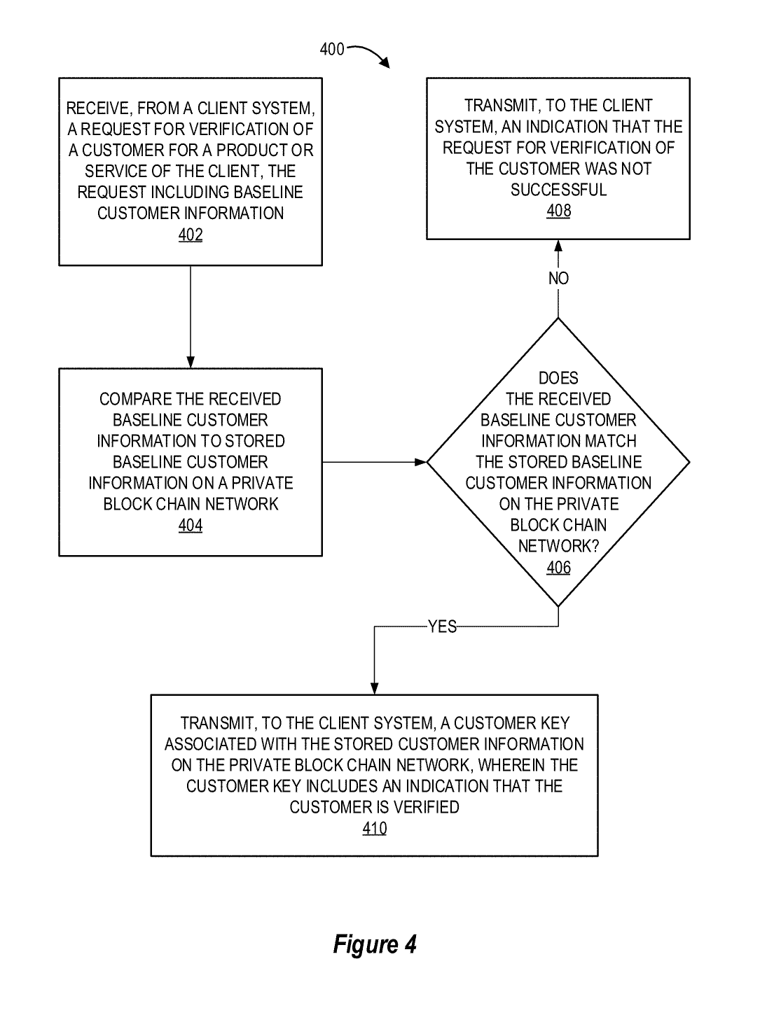

Referring now to FIG. 4, a flowchart is provided to illustrate one embodiment of a process 400 for secure verification of identity data, in accordance with embodiments of the invention. In some embodiments, the process 400 may include block 402, where the system receives, from a client system, a request for verification of a customer for a product or service of the client, where the request includes a baseline set of customer information.

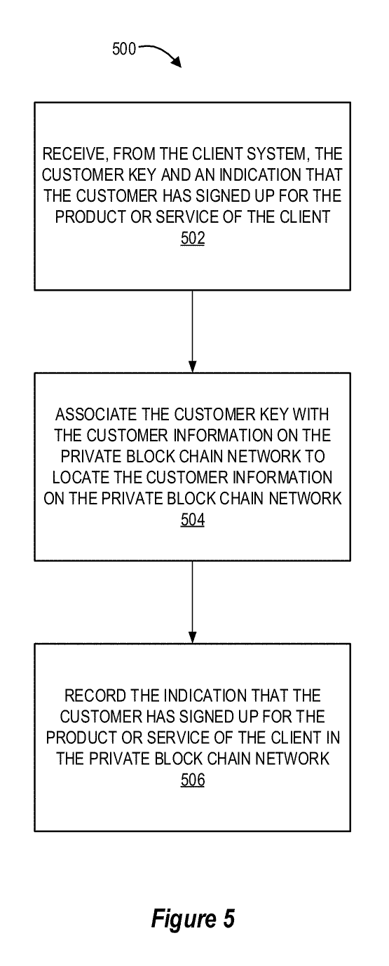

As used herein, the term “client” or “client entity” refers to an organization, company, partnership, individual, or the like that is interested in verifying an identity of a customer of the client entity, normally as part of a process to enroll that customer in a product or service of the client entity. Additionally, the term “customer,” as used herein, refers to an individual person, or a group of individuals, that are customers of the client entity and are attempting to enroll in or purchase a product or service of the client entity. The managing entity that owns or otherwise controls the system performing the customer identity verification described herein is providing a service to the client entity by verifying (or not verifying) the client entity's customer and/or performing additional steps as described in FIGS. 5-8.

Therefore, the client entity may be providing a service to its customers, the service requiring or encouraging a validation or verification of each customer before the customer can enroll in the service. In many cases, smaller client entities do not have the technical data resources, data security resources, and/or secure communication channel options necessary for secure identity verification available to them. In such cases, the client entity can turn to a managing entity system for verification of the customer.

To initiate the customer verification, the client entity’ system can transmit a request for customer verification to the managing entity system, as noted in block 402. This request of customer verification includes at least a baseline amount of customer information, referred to as the baseline customer information in block 402. In some embodiments, the baseline customer information is a minimum amount of information about an individual that the managing entity system can use to verify the identity of that individual. For example, the baseline customer information may comprise any combination of a name (e.g., full legal name, common name, aliases, and the like), physical address (e.g., work address and/or home address), phone number (e.g., cell phone number, landline number, work number, and the like), birthdate, biographical information (e.g., height, weight, eye color, hair color, and the like), personal identification number, and the like. This list is not meant to be limiting, as any type and/or amount of customer information can be considered the baseline in certain verification processes.

The amount of information required in the baseline customer information for the verification request can change based on the type of product or service that the client entity is providing. For example, if the client entity system is providing a small credit line, the baseline customer information may be only a few pieces of customer information or data. However, if the client entity is requesting customer verification for a large credit line, a life insurance policy, or some other high value product or service, the managing entity system may require more customer information in the baseline customer information (e.g., a few biographical pieces of information and a social security number, descriptions of previously purchased financial products, and the like). If the received baseline customer information does not meet the managing entity's requirement for the product or service indicated in the client entity's request for verification, the managing entity system can transmit a request for additional information to be included in the received baseline customer information.

In some embodiments, the process 400 includes block 404, where the system compares the received baseline customer information to stored baseline customer information on a private block chain network. As described in FIGS. 1 and 3, a managing entity system may own, manage, or otherwise control a customer identification database system 300 that, in some embodiments, comprises or includes a private block chain network. This customer identification database system 300 includes information about each customer that the managing entity system and/or any other entities associated with the customer identification database system 300 have interacted with in the past.

While any database system could be used to store the customer identification data, the use of a private block chain network that is securely held and managed by trusted entities and individuals provides several layers of security and confidence in the protection of, and unaltered state of the customer identification data stored therein. In some embodiments, the private block chain network comprises a distributed network of nodes managed by one or more entities, wherein the nodes are operatively coupled to each other, have at least a portion of a private block chain ledger, and share information on the ledger through electronic communication. For example, if only trusted entities (e.g., the managing entity and/or other financial entities with strict regulations, regular security tests, and the like) are able to access and/or write into nodes of the private network, then the data input recorded on the distributed ledgers of the block chain network can be trusted as an accurate representation of what was intended to be recorded.

Additionally, the distributed block chain network aspect of the database means that any changes to the data recorded in a distributed ledger are always present, as data is never “replaced” in a block chain network. Instead, a new data entry is recorded, along with an indication that the previous data entry of the same type has been updated. However, that previous data entry of the same type will remain in the block chain, along with a time-stamped note about when the data field was updated, which entity and/or individual performed the update, and any additional information about what the update to the data entails (e.g., a note about an individual moving, a correction of a typo, and the like). In this way, a permanent record of all data in the customer identification database can be viewed to ensure continuity and security of the customer data over time.

Therefore, once the system has received a request for customer verification that includes the received baseline customer information, the system can compare that received baseline customer information to the customer information stored within the private block chain network. For example, the client entity system may have sent, and the managing entity system received, a baseline set of customer data comprising a received name, a received address, a received phone number, and a received birth date. The managing entity system can then check the private block chain network of customer information to compare the received customer information with the information stored in the private block chain for that customer.

Additionally, in some embodiments, the process 400 includes block 406, where the system makes a determination as to whether the received baseline customer information matches the stored baseline customer information on the private block chain network. In some embodiments, the received baseline customer information and the stored baseline customer information must be identical for a match to have occurred. In other embodiments, the received baseline customer information and the stored baseline customer information must meet a threshold of similarity for a match to have occurred. For example, a small change or spelling error in an address or phone number may be deemed a minor inconsistency that does not necessarily indicate that someone other than the customer provided the customer's information to the client entity system, especially in cases where an important piece of customer information like a correct social security number has been provided. In another example, the phone number provided may be incorrect but other information about the customer was provided that is associated with a much higher level of confidence that the customer is in fact the individual that is providing the customer information to the client entity (e.g., a financial account number of the customer, a social security number of the customer, a password or passcode of the customer, and the like). In some embodiments, the system calculates a confidence score and determines whether there is a match based on the confidence score meeting or passing some predetermined threshold (which can vary based on the type of product or service of the client entity).

This matching step can take into account certain types of discrepancies or mismatches between the received baseline customer information and the stored baseline customer information. For example, the system can take into account the format of the customer information received or stored in the customer information database when identifying the customer information and comparing it to other received or stored customer information.

When the received baseline customer information does not match the stored customer information on the private block chain network, the system transmits, to the client system, an indication that the request for verification of the customer was not successful, as shown in block 408. This indication that the customer verification was not successful can mean at least one of several scenarios has occurred: the information that the customer gave to the client entity is outdated, the information that the customer gave to the client entity system is correct but the customer identity database has not received the updated information (which is unlikely in scenarios where the managing entity system is a financial institution system with access to official records and requires prompt notice of name, address, and other changes to personal information of its customers), the individual providing information to the client entity system acted improperly by attempting to pass off as another person but was unable to replicate the baseline customer information for that other person, and the like.

In some embodiments, the client entity system can inform its customer of the failed customer verification and request alternative or additional customer information to provide to the managing entity system again, restarting the process 400 at block 402.

When the received baseline customer information does match the stored customer information on the private block chain network, the system transmits, to the client system, a customer key associated with the stored customer information on the private block chain network, where the customer key includes an indication that the customer is verified, as shown in block 410.

In some embodiments, the system generates a customer key that is unique to this particular customer or unique to the client entity and the particular customer. The customer key can be a virtual key that is generated based on certain logic, encryption, and data value rules. For example, the system can access the customer data stored in the private block chain network, analyze certain aspects of that data and its location in the block chain network, and use a key generating algorithm to create the customer key that is unique to that customer (or the combination of the customer and the client entity). In this way, whenever the system receives the customer key in the future, the system can decode the customer key and identify information about where the customer's own information is stored within the private block chain network.

By encoding the customer key, the system can make it impossible for anyone except the managing entity (or another entity with access to the particular decoding process) from identifying or extracting personally identifiable information from the customer key. This means the customer key is a secure tool that can be communicated relatively freely to the client entity system, as the customer's identity and important financial and government information is not identifiable without additional information (i.e., the decoding process).

While the customer key may not comprise personally identifiable information of the customer, it may provide a password or authorization for its holder to view, receive, extract, or otherwise acquire some personal information of the customer. For example, the customer key can be used by the client entity system to request a subsequent verification of the customer (e.g., several months later). The client entity system can simply present the customer key to the managing entity system, which allows the managing entity system to immediately and directly check the status of the customer information within the private block chain network to identify whether the stored customer information has substantially changed. This subsequent customer verification and other supplemental steps to this process 400 are described in more detail with respect to FIGS. 5-8.

As noted in block 410 of FIG. 4, the system can provide the customer key to the client entity system as a way of indicating that the requested verification of the customer's identity was successful. Of course, the system can also simply transmit a notification of a successful verification of the customer, or provide a notice of success alongside the transmittal of the customer key.

The identity of the customer is considered “verified” when the received baseline customer information matches a set of stored baseline customer information. In reality, this simply means that the input customer data matches some stored customer data, so the actual customer may not be the one providing the customer data to the client entity, or the client entity may be entering customer data without that individual's knowledge or approval. The system will still return a notification of a verified customer data to the client entity system whenever the received customer information matches some stored customer information, because the verification essentially means that there is some individual with the same information that was provide by the client entity system.

This issue of individuals passing themselves off as other people or of client entities using customer information without consent is a problem for organizations providing identity verification services without the use of a private block chain network as their customer identification database system because the records of each request and each adjustment to the client data may simply replace the original data in the customer identification database. However, the permanent nature of the distributed ledgers in a private block chain network that are managed by trusted and regulated entities will ensure that a record exists of every request, every update to customer data, and the like over time. In this way, when the system is informed of an improper use of customer data by an individual or a client entity, the system can identify specific dates, times, transaction types, updates to data, and the like for the parties involved. This information can be very useful in a report to help identify other improper uses of customer data, prevent future improper uses of customer data, and help deter others from attempting to improperly use customer data to acquire a product or service.

Turning now to FIG. 5, a flowchart is provided to illustrate one embodiment of a process 500 for updating a customer information database, in accordance with embodiments of the invention. This process 500 may occur at any point after the client system has received the customer key, as described with respect to the process 400 of FIG. 4.

In some embodiments, the process 500 may include block 502, where the system receives, from the client system, the customer key and an indication that the customer has signed up for the product or service of the client. This customer key can be the same customer key as originally provided to the client as described in the process 400 of FIG. 4. As mentioned above, the customer key may be encoded in a way that protects any personally identifiable information of the customer, such that any holder or interceptor of the customer key cannot identify the customer, the product or service of the customer, or any information about the customer from the customer key alone. However, the managing entity system can decode the customer key with its own decoder to identify the customer and/or a location within the private block chain network where the information associated with the customer is located.

The product or service of the client entity may be any product or service that requires, or is improved, by the client entity's confirmation that the customer is a verified individual. Additionally, the product or service is usually of a financial nature, or is of enough significance to warrant a recording of this product or service in the customer data for that customer. Therefore, the remaining steps of this process 500 will describe how the managing entity system can add the new product or service, along with any other useful information about the client entity system, the verified nature of the customer, the time and date of the service, any new or updated customer information, and the like, to the private block chain network.

In some embodiments, the process 500 includes block 504, where the system associates the customer key with the customer information on the private block chain network to locate the customer information on the private block chain network. As mentioned above, the managing entity system may decode the customer key once it is received to identify the identity of the customer and/or the location within the private block chain network associated with the customer's identity and other customer information.

Finally, in some embodiments, the process 500 includes block 506, where the system records the indication that the customer has signed up for the product or service of the client on the private block chain network. Because the customer information database is a private block chain network, a permanent record of the customer's enrollment in the product or service of the client system, the name and other information about the client system, information about the product or service in which the customer has enrolled, and other useful information can be added to the block chain network.

In some embodiments, the customer may provide additional customer information in its application to enroll in the product or service of the client entity. In such embodiments, the client entity system can provide this information to the managing entity system. Because the managing entity system has verified the customer based on other information (e.g., enough other information like name, birth date, social security number, and the like), the managing entity system can act with a high degree of confidence in knowing that any additional information provided in relation to the customer has a high likelihood of being accurate. Therefore, other information about a new address, a new phone number, a new place of employment, or the like may be entered into the private block chain network as the updated or new customer information for that customer.

In this way, the products or services that the customer has entered into, as well as the new and changed customer information, can be added to the private block chain network of the managing entity system to continuously maintain, grow, and update the database of customer information for each customer that interacts with the managing entity system and/or the client entity system.

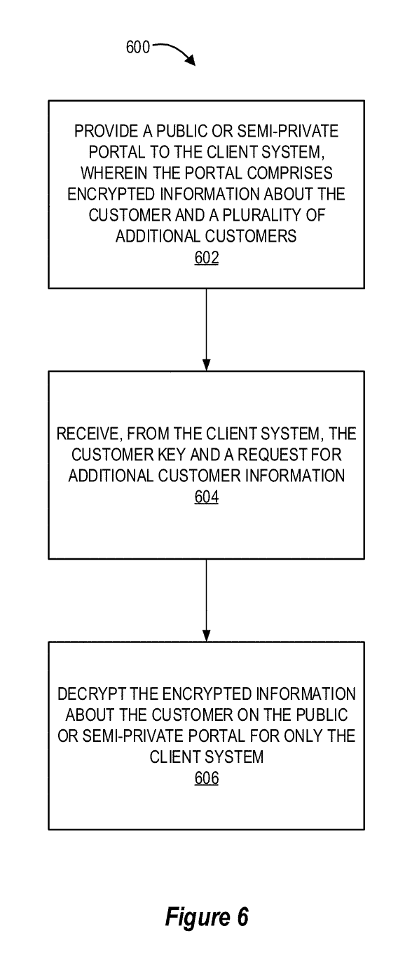

Referring now to FIG. 6, a flowchart is provided to illustrate one embodiment of a process 600 for providing an online portal to a client system for viewing customer information in response to the client system providing the customer key, in accordance with embodiments of the invention. This process 600 can occur immediately after the process 400 of FIG. 4, or it may occur at some later point in time. For example, the client system may want to check the information for a particular customer several months after originally receiving a customer key for that customer. This process 600 allows the client system to view some customer information without granting access to the private block chain network.

In some embodiments, the process 600 may include block 602, where the system provides a public or semi-private portal to the client system, wherein the portal comprises encrypted information about the customer and a plurality of additional customers. Once the unique virtual customer key has been generated for a customer, the client entity that has possession of the virtual customer key can use that customer key as a tool to access additional information, receive subsequent verification, or other procedures. To facilitate these additional procedures, the managing entity system can provide a web portal that is open to its clients, or anyone with access to the virtual customer key. The portal may be public in the sense that anyone can generally access the portal, but the customer information or verification information within the portal may be hidden, encrypted, or otherwise protected from general access. The portal may be semi-private in the sense that a username and passcode are required to access the portal at all, and at least some of the customer information stored on the portal may be hidden, encrypted, or protected from access until an associated customer key is provided.

In some embodiments, this portal can be provided to the client entity system such that one or more steps of any of the other processes 400, 500, 700 and/or 800 described herein can be performed through the portal.

In some embodiments, the portal comprises access to a public or semi-private block chain network comprising some or all of the data from the private block chain network, but where the customer information is encrypted or hidden, and/or only certain entities (e.g., the managing entity) have data writing permissions for each node of the public or semi-private block chain network.

The process 600 may also include block 604, where the system receives, from the client system, the customer key and a request for additional customer information. In some scenarios, the client entity system is providing a product or service to the customer where baseline information is required to verify the identity of the customer, but additional information may be helpful in actually providing the product or service to the customer. For example, the client entity system may be providing a line of credit to the customer that requires a name, phone number, address, date of birth, and social security number as the baseline customer information for verification purposes (i.e., the process 400 of FIG. 4). However, the client entity system may additionally desire financial account information, credit score information, guarantor information, and the like for the customer to better understand the customer's situation and be better prepared to provide an appropriate line of credit to the customer. Therefore, the client entity system may request this additional customer information.

By providing the customer key along with the request for additional information, the client entity system is able to protect the identity of the customer during the transmission of the customer key (because the customer key may not include personally identifiable information), while providing a very useful tool to the managing entity system for quickly identifying the customer and/or the location of the customer information in the private block chain database.

Finally, in some embodiments, the process 600 includes block 606, where the system decrypts the encrypted information about the customer on the public or semi-private portal for only the client system. In some embodiments, the system copies the data from the private block chain network and provides it to the client entity system via the portal. In embodiments where the portal includes at least a partial reproduction of the private block chain network in the form of a public or semi-private block chain network, the system may cause the requested information to be available, decrypted, viewable, extractable, or the like within the portal.

In some embodiments, the customer key can be used as a decryption tool for the client entity system within the portal. For example, the client entity system may be able to enter the customer key for a particular customer into the portal, along with a request for additional information about the customer or for a subsequent verification of the customer. The portal may be configured to use this customer key to decrypt the encrypted customer information stored within the portal.

In some embodiments, the decrypted portion of the stored customer information is displayed on the public or semi-private portal for the client system for a predetermined period of time.

The customer key may also have an expiration date or time, which may be based on the level of relationship between the managing entity and the client entity system, the level of baseline customer information received, the product or service of the client entity system that is part of the request for customer identity verification, and the like. For example, the customer key may be available for a few days to allow the client entity system to verify the identity of the customer and provide an indication that the customer enrolled in the product or service of the client entity. Additionally or alternatively, the customer key may have a fixed number of use iterations, where the customer key can be used only the permitted number of times before expiring or otherwise losing its usefulness. In this way, the system can permit the client entity system to use the customer key for additional procedures while still protecting the overall security of the customer information over time.

In some embodiments, the client entity system may have requested the additional information (e.g., financial account information, additional financial products owned or previously owned by the customer, credit information, and the like) directly from the customer, but can use the process 600 described herein to check the accuracy and completeness of the additional information provided by the customer. In some embodiments, the system can perform such accuracy and completeness checks on behalf of the client entity system, and would therefore need this additional information along with the customer key and the request for a check on the additional information.

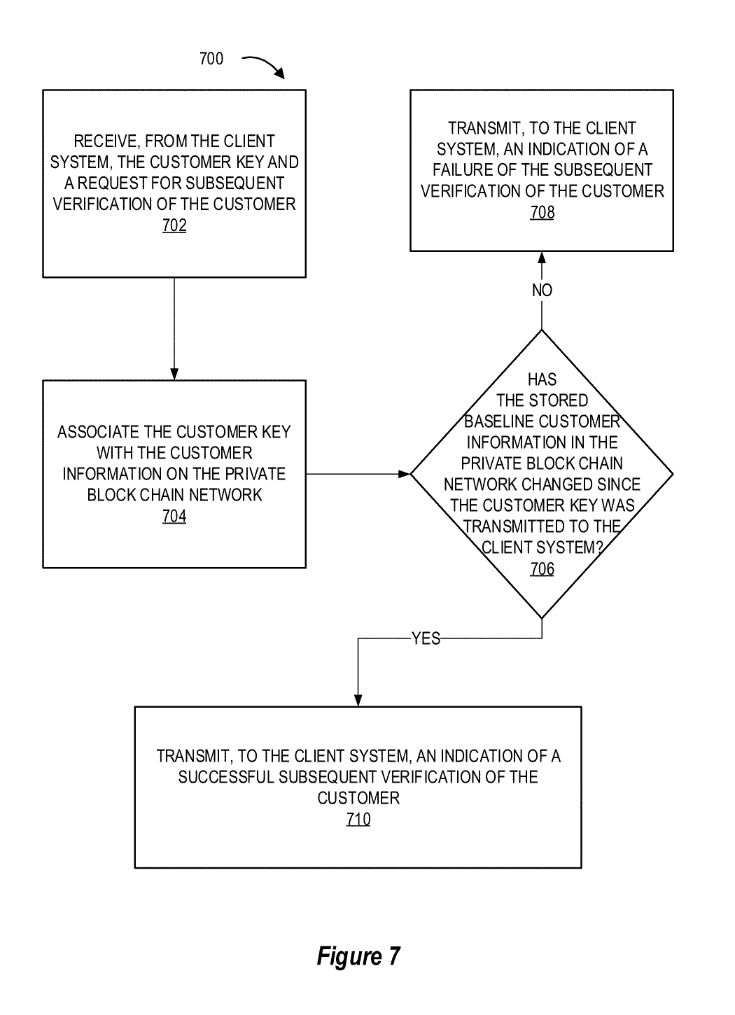

Referring now to FIG. 7, a flowchart is provided to illustrate one embodiment of a process 700 for subsequent verification of an identity of a customer, at some point in time after an initial verification under the process 400 described in FIG. 4, in accordance with embodiments of the invention. In some embodiments, the process 700 may include block 702, where the system receives, from the client system, the customer key and a request for subsequent verification of the customer. In some cases, the customer did not enroll in the product or service of the client entity at the time of the initial verification (i.e., under the process 400), and in other embodiments the customer did initially enroll in the product or service and is now requesting enrollment in an additional or new product or service of the client entity. Either way, the client entity may desire or be required to re-verify the identity of the customer before providing the product or service at this later point in time from the initial verification of the customer's identity.

In some embodiments, the process 700 includes block 704, where the system associates the customer key with the customer information on the private block chain network. Again, the customer key may be a unique virtual key that does not contain personally identifiable information on its own, but can be decoded by the managing entity system to identify the identity of the customer and/or the location of the customer information within the private block chain network. This means the system can identify the individual associated with the customer key and locate the appropriate customer information within the private block chain network.

Additionally, in some embodiments, the process 700 includes block 706, where the system determines whether the stored baseline customer information in the private block chain network has changed since the customer key was transmitted to the client system. Ultimately, the system is trying to determine whether the identity of the customer can still be verified. If the information about the customer has not changed, then the customer's identity can be verified. However, if certain information about the customer has changed, the system may not be able to confidently determine that the identity of the customer is still verified. For example, if the legal name of the customer has changed since the customer was verified by the managing entity system for the client entity system, the system cannot easily assert that the customer identity continues to be verified.

In some embodiments, the system may make a determination that the customer identity is verified even though a small change to the customer data has occurred since the customer key was initially transmitted to the client entity system. For example, if the managing entity system has received an indication from the customer or a third party that the customer's phone number has changed, but the rest of the customer information remains the same, then the system can determine with a high enough confidence score that the customer identity is still verified. In such embodiments, the system can provide the updated phone number along with any response of a successful verification of the customer identity.

When the baseline customer information stored in the private block chain network has changed, the system transmits, to the client system, an indication of a failure of the subsequent verification of the customer. In such cases, the system can request the client entity system to provide a new set of baseline customer information to begin the process 400 of FIG. 4 at block 402.

However, when the baseline customer information stored in the private block chain network has not changed (or has changed by an amount small enough to maintain the system's confidence in the verification of the customer), the system transmits, to the client system, an indication of a successful subsequent verification of the customer. This indication may comprise or include the customer key, a new customer key, a simple note of success, or the like. As noted above, any new or updated information associated with the customer and/or the customer's identity may be transmitted to the client entity system, when appropriate.

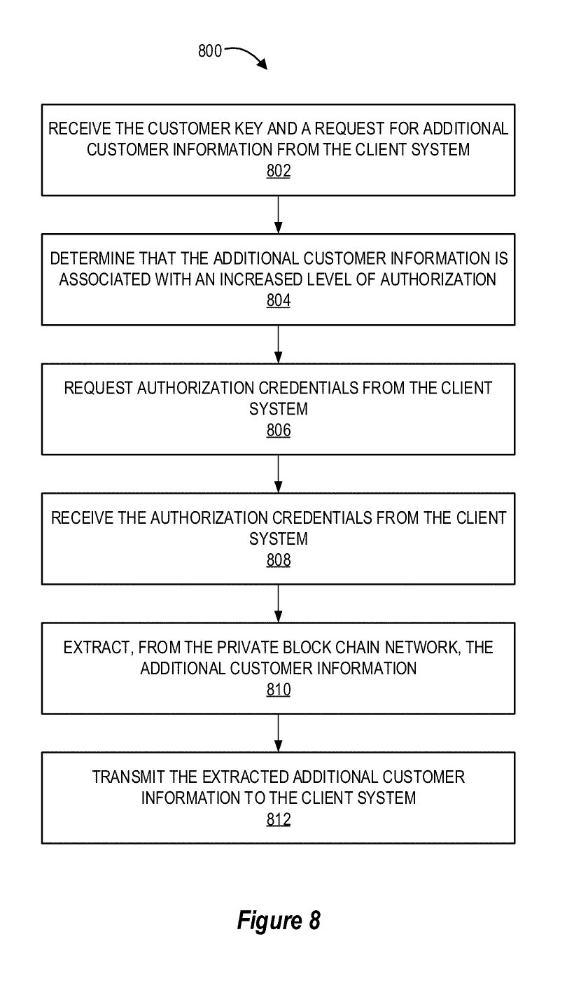

Referring now to FIG. 8, a flowchart is provided to illustrate one embodiment of a process 800 for providing additional customer information to the client system, in accordance with embodiments of the invention. In some embodiments, this process 800 may be incorporated with the process 600 for requesting additional information about a customer via a portal. As such, one or more of the steps provided herein can be performed by the system within or through a web portal as described with respect to FIG. 6.

To begin, the process 800 may include block 802, where the system receives the customer key and a request for additional customer information from the client system. Again, the client entity system may require additional information, beyond the baseline customer information about the customer to provide a better or more complete product or service to the customer.

In some embodiments, the process 800 includes block 804, where the system determines that the additional customer information is associated with an increased level of authorization. For example, the requested additional customer information may require a higher security clearance, may require additional safety procedures to be in place before being shared, may be accessed by only those entities with proper safety procedures in place to view or store the information securely, and the like.

In some embodiments, the process 800 includes block 806, where the system requests authorization credentials from the client system. These authorization credentials may be comprise a client entity passcode (e.g., a passcode provided to the client entity that is associated with a level of security or regulatory clearance to access the additional data), a customer passcode (e.g., a passcode provided by the managing entity system to the customer that the customer can provide to entities that desire to access or receive the additional information about the customer), supplemental customer information that would be associated with an equal or higher authentication level, and the like.

The process 800 may also include block 808, where the system receives the authorization credentials from the client system. The system can check the authorization credentials to ensure that they are correct. In scenarios where the authorization credentials are incorrect, the system can reject the request for additional information or apply even more stringent security measures to a future request for the additional customer information.

In some embodiments, the process 800 includes block 810, where the system extracts, from the private block chain network, the additional customer information. Again, the unique virtual key is associated with the customer information in the private block chain network, so the system can decode the customer key to identify the customer and/or identify the location within the private block chain network that is associated with the information about the customer, including the additional customer information.

Finally, in some embodiments, the process 800 includes block 812, where the system transmits the extracted additional customer information to the client system. In some embodiments, the extracted customer information is encrypted and transmitted to the client system via a secure, dedicated communication channel. In this way, the system continues to protect the identity of the customer, the security of the important and personal customer data, and the integrity of the identity verification service.

In some embodiments, the customer key provided to the client comprises a “public key” (e.g., a block explorer) that is associated with the block chain network database managed by the managing entity (or other trusted entities). This public key is different from a “private key” that would be held by the managing entity or other block chain-controlling entities or administrators. The private key would grant access to potentially sensitive information stored in the block chain network, permits the private key holder to write to the block chain network, and the like. The public key, on the other hand, would allow the public key holder to view a code or mnemonic associated with the information stored on the block chain network. For example, the public key, when queried with the block chain network, could allow the public key holder to view a status report of “baseline customer information has been received for this identity,” “baseline customer information has not changed for this identity,” or the like. In another example, the block chain network may permit the public key holder (e.g., the client) to view information that is in addition to the baseline customer information. This additional information may be available in levels (e.g., depending on the level of access permitted by the public key, as generated by the managing entity).

In other embodiments, a private key is provided to the client, where this private key provides some permissions or rights to a public or semi-private block chain network. For example, the client can provide the indication that the customer has enrolled in the product or service of the client to the public or semi-private block chain network. The system could automatically record any such changes made by the client using the private key to the separate private block chain network that serves as the actual customer information database. In other embodiments, the administrators of the private block chain can receive submissions from the client entity to adjust, correct, or alter the private block chain. In some cases, the addition to the public or semi-private block chain network can automatically trigger a submission to the managing entity or another administrator of the private block chain network that serves as the secure customer information database.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, and the like), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. A system for secure verification of identity data, the system comprising:
a memory device; and
a processing device operatively coupled to the memory device, wherein the processing device is configured to execute computer-readable program code to:
receive, from a client system associated with a client, a request for verification of a customer for a product or service of the client, wherein the request for verification of the customer comprises baseline customer information;
compare the received baseline customer information to stored baseline customer information on a private block chain network;
determine whether the received baseline customer information matches the stored baseline customer information on the private block chain network; and
in response to determining that the received baseline customer information does not match the stored customer information on the private block chain network, transmit, to the client system, an indication that the request for verification of the customer was not successful; or
in response to determining that the received baseline customer information does match the stored baseline customer information on the private block chain network, transmit, to the client system, a customer key associated with the stored customer information on the private block chain network, wherein the customer key includes an indication that the customer is verified.

2. The system of claim 1, wherein the private block chain network comprises a distributed network of nodes managed by one or more entities, wherein the nodes are operatively coupled to each other, have at least a portion of a private block chain ledger, and share information on the ledger through electronic communication.

3. The system of claim 1, wherein the processing device is further configured to execute computer-readable program code to:
receive, from the client system, the customer key and an indication that the customer has signed up for the product or service of the client;
associate the customer key with the stored customer information on the private block chain network to locate the stored customer information on the private block chain network; and
record the indication that the customer has signed up for the product or service of the client in the private block chain network.

4. The system of claim 1, wherein the customer key does not comprise personally identifiable information of the customer.

5. The system of claim 1, wherein the processing device is further configured to execute computer-readable program code to:
provide a public or semi-private portal to the client system, wherein the portal comprises encrypted information about the customer and a plurality of additional customers;
receive the customer key and a request for additional customer information from the client system; and
in response to receiving the customer key, decrypt the encrypted information about the customer on the public or semi-private portal for only the client system.

6. The system of claim 5, wherein the decrypted portion of the stored customer information is displayed on the public or semi-private portal for only the client system for a predetermined period of time.

7. The system of claim 1, wherein the processing device is further configured to execute computer-readable program code to:
receive, from the client system, the customer key and a request for a subsequent verification of the customer;
associate the customer key with the stored customer information on the private block chain network to determine whether the stored baseline customer information in the private block chain network has changed since the customer key was transmitted to the client system; and
in response to determining that the stored baseline customer information has changed, transmit, to the client system, an indication of a failure of the subsequent verification of the customer; or
in response to determining that the stored baseline customer information has not changed, transmit, to the client system, an indication of a success of the subsequent verification of the customer.

8. The system of claim 1, wherein the processing device is further configured to execute computer-readable program code to:
receive the customer key and a request for additional customer information from the client system;
determine that the additional customer information is associated with an increased level of authorization;
request authorization credentials from the client system, wherein the authorization credentials comprise supplemental customer information beyond the baseline customer information or a unique passcode associated with the customer;
receive the authorization credentials from the client system;
in response to receiving the authorization credentials from the client system, extract, from the private block chain network, the additional customer information; and
transmit the extracted additional customer information to the client system.

9. The system of claim 8, wherein the extracted additional customer information is encrypted and transmitted to the client system via a secure communication channel.

10. A computer program product for secure verification of identity data, the computer program product comprising at least one non-transitory computer readable medium comprising computer readable instructions, the instructions comprising instructions for:
receiving, from a client system associated with a client, a request for verification of a customer for a product or service of the client, wherein the request for verification of the customer comprises baseline customer information;
comparing the received baseline customer information to stored baseline customer information on a private block chain network;
determining whether the received baseline customer information matches the stored baseline customer information on the private block chain network; and
in response to determining that the received baseline customer information does not match the stored customer information on the private block chain network, transmitting, to the client system, an indication that the request for verification of the customer was not successful; or
in response to determining that the received baseline customer information does match the stored baseline customer information on the private block chain network, transmitting, to the client system, a customer key associated with the stored customer information on the private block chain network, wherein the customer key includes an indication that the customer is verified.

11. The computer program product of claim 10, wherein the private block chain network comprises a distributed network of nodes managed by one or more entities, wherein the nodes are operatively coupled to each other, have at least a portion of a private block chain ledger, and share information on the ledger through electronic communication.

12. The computer program product of claim 10, wherein the computer readable instructions further comprise instructions for:
receiving, from the client system, the customer key and an indication that the customer has signed up for the product or service of the client;
associating the customer key with the stored customer information on the private block chain network to locate the stored customer information on the private block chain network; and
recording the indication that the customer has signed up for the product or service of the client in the private block chain network.

13. The computer program product of claim 10, wherein the customer key does not comprise personally identifiable information of the customer.

14. The computer program product of claim 10, wherein the computer readable instructions further comprise instructions for:
providing a public or semi-private portal to the client system, wherein the portal comprises encrypted information about the customer and a plurality of additional customers;
receiving the customer key and a request for additional customer information from the client system; and
in response to receiving the customer key, decrypting the encrypted information about the customer on the public or semi-private portal for only the client system, wherein the decrypted portion of the stored customer information is displayed on the public or semi-private portal for only the client system for a predetermined period of time.

15. The computer program product of claim 10, wherein the computer readable instructions further comprise instructions for:
receiving, from the client system, the customer key and a request for a subsequent verification of the customer;
associating the customer key with the stored customer information on the private block chain network to determine whether the stored baseline customer information in the private block chain network has changed since the customer key was transmitted to the client system; and
in response to determining that the stored baseline customer information has changed, transmitting, to the client system, an indication of a failure of the subsequent verification of the customer; or
in response to determining that the stored baseline customer information has not changed, transmitting, to the client system, an indication of a success of the subsequent verification of the customer.

16. The computer program product of claim 10, wherein the computer readable instructions further comprise instructions for:
receiving the customer key and a request for additional customer information from the client system;
determining that the additional customer information is associated with an increased level of authorization;
requesting authorization credentials from the client system, wherein the authorization credentials comprise supplemental customer information beyond the baseline customer information or a unique passcode associated with the customer;
receiving the authorization credentials from the client system;
in response to receiving the authorization credentials from the client system, extract, from the private block chain network, the additional customer information; and
transmitting the extracted additional customer information to the client system, wherein the extracted additional customer information is encrypted and transmitted to the client system via a secure communication channel.

17. A computer implemented method for secure verification of identity data, said computer implemented method comprising:
providing a computing system comprising a computer processing device and a non-transitory computer readable medium, where the computer readable medium comprises configured computer program instruction code, such that when said instruction code is operated by said computer processing device, said computer processing device performs the following operations:
receiving, from a client system associated with a client, a request for verification of a customer for a product or service of the client, wherein the request for verification of the customer comprises baseline customer information;
comparing the received baseline customer information to stored baseline customer information on a private block chain network;
determining whether the received baseline customer information matches the stored baseline customer information on the private block chain network; and
in response to determining that the received baseline customer information does not match the stored customer information on the private block chain network, transmitting, to the client system, an indication that the request for verification of the customer was not successful; or
in response to determining that the received baseline customer information does match the stored baseline customer information on the private block chain network, transmitting, to the client system, a customer key associated with the stored customer information on the private block chain network, wherein the customer key includes an indication that the customer is verified.

18. The computer implemented method of claim 17, wherein the private block chain network comprises a distributed network of nodes managed by one or more entities, wherein the nodes are operatively coupled to each other, have at least a portion of a private block chain ledger, and share information on the ledger through electronic communication.

19. The computer program product of claim 17, further comprising:
receiving, from the client system, the customer key and an indication that the customer has signed up for the product or service of the client;
associating the customer key with the stored customer information on the private block chain network to locate the stored customer information on the private block chain network; and
recording the indication that the customer has signed up for the product or service of the client in the private block chain network.

20. The computer program product of claim 17, further comprising:
providing a public or semi-private portal to the client system, wherein the portal comprises encrypted information about the customer and a plurality of additional customers;
receiving the customer key and a request for additional customer information from the client system; and
in response to receiving the customer key, decrypting the encrypted information about the customer on the public or semi-private portal for only the client system, wherein the decrypted portion of the stored customer information is displayed on the public or semi-private portal for only the client system for a predetermined period of time.
